(19) United States
(12) Patent Application Publication
(10) Pub. No.: US 2006/0147720 A1
(43) Pub. Date: Jul. 6, 2006

(54) Aqueous phenoxy adhesives

(75) Inventor: Michael J. Moore, Canton, MI (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: Freudenberg-NOK General Partnership

(21) Appl. No.: 11/029,999

(22) Filed: Jan. 5, 2005

(51) Int. Cl. B32B 27/38; B32B 27/08; C08L 63/00; C08G 65/00

(52) U.S. Cl. 428/414; 428/421; 523/402; 525/528

(57) ABSTRACT

An aqueous dispersion composition of phenoxy resin and curing agent provides an adhesive blend which is cured with one of two types of curing agents: a first type based upon phenolic resin, epoxy resin, and/or melamine formaldehyde resin; and a second type based upon water-dispersible polyisocyanate. The adhesive dispersion is cured in making composites having structural materials of any of polytetrafluoroethylene, thermoplastic vulcanizate, thermoplastic elastomer, and metal. Articles made of such composites include dynamic and static seals, gaskets, pump diaphragms, hoses, encoders, and o-rings.

### INTRODUCTION

This invention relates to phenoxy adhesives, to composites made with phenoxy adhesives, and to articles formed of such composites. In particular, the present invention relates to phenoxy-based adhesives cured from an aqueous phenoxy adhesive blend.

Composites are important materials in enabling many of the benefits of modern life. Composites provide multilayered structures having individual layers made of metal, polymer, or ceramic. Each layer contributes to the overall performance of the composite as viewed from the intended application. This is especially true of the outside layers of a composite.

The adhesive layer of a composite, while important in holding various layers together, is also frequently the basis for the weak point respective to the overall integrity of the composite. The adhesive layer of a composite is also frequently the most difficult to handle in assembling the composite.

Phenoxy resins are useful adhesives for bonding thermoplastic vulcanizates. In this regard, phenoxy resins provide a transparent, tough material having good dimensional stability and adhesive properties. In some applications, phenoxy resins are used in copolymer thermoplastic form, optionally with solvents to enable smooth deposition on a substrate where the phenoxy will function as an adhesive. In such applications, however, the phenoxy thermoplastic adhesive does not demonstrate good resistance to automotive fluids such as gasoline or engine oil. When certain curing agents are added, the phenoxy can be crosslinked to provide good resistance to aliphatic hydrocarbons, but only after curing at an elevated temperature; unfortunately, such heat treatment warps or otherwise dimensionally modifies articles made with the phenoxy adhesive.

Another general difficulty in use of solvent-based adhesives relates to maintenance of a safe manufacturing environment; in this regard, solvent-based adhesives “release” solvent vapors during application and curing; and these vapors need to be managed so that worker exposure is acceptably minimized.

Gasketry, seals, encoders made of thermoplastic vulcanizate material, and other composite articles made for use in, for example, engines need to possess properties of good resistance to gasoline and engine oil. Such articles also benefit from consistency in dimensional properties.

A desirable phenoxy-based adhesive, therefore, would not release solvent during deposition and curing, would not require heat treatment, and would be highly resistant to typical automotive fluids. This and other needs are achieved with the invention.

### SUMMARY

The invention provides a dispersion composition, comprising:

(a) from about 30 to about 95 weight percent water;

(b) phenoxy resin dispersed in the water; and

(c) crosslinking agent for the phenoxy resin dispersed in the water.

In one aspect, the phenoxy is a copolymer derived from bisphenol A and epichlorohydrin. In another aspect, the phenoxy has the repeating structural formula
—[OC₆H₄C(CH₃)₂C₆H₄OCH₂CH(OH)CH₂]ₙ—

where n is from about 35 to about 120.

In one aspect, the crosslinking agent is any of phenolic resin, epoxy resin, melamine formaldehyde resin, or combinations of these.

In another aspect, the crosslinking agent is a water-dispersible polyisocyanate.

In one aspect, the phenoxy has a molecular weight of from about 10,000 to about 35,000, and the crosslinking agent has a molecular weight of from about 1,000 to about 4,000.

The dispersion composition is, in one aspect, an emulsion; in another aspect, the dispersion composition is a suspension.

The invention is also for a method for making an aqueous adhesive dispersion composition according to the above formulations by dispersively admixing phenoxy resin and crosslinking agent for the phenoxy resin into water, where the water comprises from about 30 to about 95 weight percent of the aqueous dispersion.

The invention is also for a composite made of

(a) a first structural layer comprising a first material of any of polytetrafluoroethylene, thermoplastic vulcanizate, thermoplastic elastomer, and metal;

(b) a second structural layer comprising a second material of any of polytetrafluoroethylene, thermoplastic vulcanizate, thermoplastic elastomer, and metal; and

(c) an adhesive layer disposed between the first and second structural layers, the adhesive layer cured from an adhesive dispersion composition comprising from about 30 to about 95 weight percent water, phenoxy resin dispersed in the water, and crosslinking agent for the phenoxy resin dispersed in the water.

In one composite aspect, the thermoplastic elastomer of either of the first and the second layer is polyester elastomer.

The invention is also for making a composite by:

(a) admixing an aqueous adhesive dispersion of phenoxy resin and cross-linking agent for the phenoxy resin, where water comprises from about 30 to about 95 weight percent of the aqueous dispersion;

(b) providing a first structural layer for the composite, the first structural layer comprising a first material that is any of polytetrafluoroethylene, thermoplastic vulcanizate, thermoplastic elastomer, and metal;

(c) applying the adhesive as an adhesive layer to the first layer;

(d) attaching a second structural layer against the adhesive layer, the second structural layer comprising a second material that is any of polytetrafluoroethylene, thermoplastic vulcanizate, thermoplastic elastomer, and metal; and

(e) curing the adhesive layer.

The invention is also for particular article (such as a dynamic seal, a static seal, a gasket, a pump diaphragm, a hose, an encoder, or an o-ring) made by use of the above formulations and methods.

Further areas of applicability will become apparent from the detailed description provided hereinafter. It should be understood that the detailed description and specific examples, while indicating embodiments of the invention, are intended for purposes of illustration only and are not intended to limit the scope of the invention.

### DESCRIPTION

The following definitions and non-limiting guidelines must be considered in reviewing the description of this invention set forth herein.

The headings (such as “Introduction” and “Summary”) used herein are intended only for general organization of topics within the disclosure of the invention, and are not intended to limit the disclosure of the invention or any aspect thereof. In particular, subject matter disclosed in the “Introduction” may include aspects of technology within the scope of the invention, and may not constitute a recitation of prior art. Subject matter disclosed in the “Summary” is not an exhaustive or complete disclosure of the entire scope of the invention or any embodiments thereof.

The citation of references herein does not constitute an admission that those references are prior art or have any relevance to the patentability of the invention disclosed herein. All references cited in the Description section of this specification are hereby incorporated by reference in their entirety.

The description and specific examples, while indicating embodiments of the invention, are intended for purposes of illustration only and are not intended to limit the scope of the invention. Moreover, recitation of multiple embodiments having stated features is not intended to exclude other embodiments having additional features, or other embodiments incorporating different combinations the stated of features.

As used herein, the words “preferred” and “preferably” refer to embodiments of the invention that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, the word ‘include,” and its variants, is intended to be non-limiting, such that recitation of items in a list is not to the exclusion of other like items that may also be useful in the materials, compositions, devices, and methods of this invention.

Most items of manufacture represent an intersection of considerations in both mechanical design and in materials design. In this regard, improvements in materials frequently are intertwined with improvements in mechanical design. The embodiments describe compounds, compositions, assemblies, and manufactured items that enable improvements in adhesives to be fully exploited.

The examples and other embodiments described herein are exemplary and not intended to be limiting in describing the full scope of compositions and methods of this invention. Equivalent changes, modifications and variations of specific embodiments, materials, compositions and methods may be made within the scope of the present invention, with substantially similar results.

The embodiments relate to aqueous phenoxy adhesive blends and to cured adhesive layers derived from those aqueous phenoxy adhesive blends.

Phenoxy resin provides a high molecular weight thermoplastic copolymer having good adhesive properties, dimensional stability, and good resistance to many acids, alkalies, and aliphatic hydrocarbons. Phenoxy resins are usually derived from the same materials as epoxy resins, but phenoxy resins do not have epoxy groups on their molecular chains. Phenoxy resins do have hydroxy groups on their molecular chains; these hydroxy groups enable crosslinking (curing) with isocyanates, anhydrides, triazines, and melamines. Phenoxies are copolymers that are usually derived from bisphenol A and epichlorohydrin and have the repeating structural formula

Formula I:
—[OC₆H₄C(CH₃)₂C₆H₄OCH₂CH(OH)CH₂]ₙ—.

In preferred embodiments of aqueous phenoxy dispersion adhesive, “n” in the above structural formula (Formula I) is from about 35 to about 120 (preferably from about 35 to about 105; more preferably at about 100). The phenoxy accordingly has a molecular weight of from about 10,000 to about 35,000 (preferably from about 10,000 to about 30,000; more preferably about 28,400).

In one embodiment of dispersion adhesive composition, phenoxy resin and a crosslinking (curing) agent for the phenoxy resin are dispersed in water, with water being from about 30 to about 95 weight percent of the composition. Two general types of crosslinking (curing) agents are effective for the adhesive: a first type of any of phenolic resin, epoxy resin, and melamine formaldehyde resin (or combinations of these); and a second type as a water-dispersible polyisocyanate. In this regard, the crosslinking (curing) agent has a lower molecular weight than the phenoxy in Formula I; whereas Formula I indicates a molecular weight of from about 10,000 to about 35,000, the curing agent has a preferably molecular weight of from about 1,000 to about 4,000.

When the first type (phenolic resin, epoxy resin, and/or melamine formaldehyde resin) of crosslinking (curing) agent is used, the phenoxy resin is from about 30 to about 70 (preferably, from about 45 to about 55) weight percent of a dry weight combination of the phenoxy resin and the crosslinking (curing) agent.

When the second type (polyisocyanate) of crosslinking (curing) agent is used, the phenoxy resin is from about 70 to about 90 (preferably, from about 80 to about 90) weight percent of a dry weight combination of the phenoxy resin and the polyisocyanate crosslinking (curing) agent. The water dispersible di-isocyanate curing agent is highly preferred respective to its benefits for room temperature curing. In this regard, aqueous phenoxies cured with a dispersible di-isocyanate curing agent cure with relatively minimal emissions to the environment and also do not require as much energy to cure (with some further environmental benefit insofar as heat energy beyond that needed to sustain room temperature does not need to be generated).

Depending upon the particular molecular weights, concentrations, and temperatures, the aqueous phenoxy adhesive dispersion is, in one embodiment, a suspension of essentially solid micro-particulate phenoxy and crosslinking (curing) agent in water; in an alternative embodiment, the aqueous phenoxy adhesive dispersion is an emulsion of essentially liquid phenoxy and crosslinking (curing) agent in water.

The aqueous adhesive dispersion is made in one embodiment by dispersively admixing phenoxy resin and crosslinking agent according to the above proportions into water. In an alternative embodiment where use of the adhesive will not be as immediate, a first precursor admixture is made by dispersively admixing phenoxy resin with water; a second precursor admixture is made by dispersively admixing crosslinking agent with water; and the adhesive is made by admixing (combining) the first and second admixtures. In one embodiment, the first precursor admixture is PKHW 35 from Phenoxy Associates. Proportioning according to the alternative embodiment is managed to ensure that final quantities of water, phenoxy, and curing agent (after the first and second precursors are admixed into the adhesive) provide the desired adhesive composition. The adhesive (or final adhesive) of either of these two embodiments should be actively admixed for from about 12 to about 20 minutes (preferably for about 15 minutes).

In an embodiment having the first type (phenolic resin, epoxy resin, and/or melamine formaldehyde resin) of crosslinking (curing) agent, the dispersion adhesive should be applied within about a month after the adhesive is admixed. In an embodiment having the (polyisocyanate) of crosslinking (curing) agent, the dispersion adhesive should be applied within about 2 hours after the adhesive is admixed.

The adhesive is especially useful for making composites. In this regard, composites of interest have a first structural layer of polytetrafluoroethylene, thermoplastic vulcanizate, thermoplastic elastomer, or metal. The composites also have a second structural layer taken from the same set of material types. In one embodiment, the first structural layer and the second structural layer are of the same material type. In an alternative embodiment, the second layer is of a different material than the first layer.

It should be noted that the term “structural material” denotes the nature of the contribution of the respective layer to the overall performance of the composite as viewed from the intended application of the composite where the nature of the structural layers of a composite determine its utility in the application (under the presumptions that adhesion between the layers is acceptable for the application and that details of the adhesive system in the composite are not otherwise of performance interest in the application of the composite). In this regard, a structural layer in a three layer composite having a first structural layer, an adhesive layer, and a second structural layer (in a composite having two structural layers and an adhesive layer binding both structural layers into the composite) provides any desired performance property to the composite as a structure in its intended application. This desired performance property provides to the composite any of, without limitation, rigid or flexible support (a structural support layer), chemical or solvent resistance, thermal resistance, flame resistance, adsorption capability, absorption capability, robustness under compression, robustness under tension, any combination of these, and/or the like.

As will be appreciated by those of skill, structural support layers are also provided as internal layers for composites having more than three layers. In this regard, the outside structural layers (for composites having more than three layers) provide performance properties to the composite any of, without limitation, rigid or flexible support (a structural support layer), chemical or solvent resistance, thermal resistance, flame resistance, adsorption capability, absorption capability, robustness under compression, robustness under tension, any combination of these, and/or the like. Internal structural layers (for composites having more than three layers) are usually then engineered to augment properties of the composite related to rigid or flexible support, robustness under compression, and robustness under tension. As should be appreciated by those of skill, the discussion herein respective to adhesion of structural layers in three layer composites having a first structural layer, an adhesive layer, and a second structural layer is also readily applicable to adhesion between structural (non-adhesive layers) in composites having more than two structural layers.

In one embodiment, the aqueous phenoxy adhesive dispersion is disposed (applied) as an adhesive layer between the first and second structural layers, and the composite is crosslinked (cured). In an alternative embodiment, the adhesive layer is disposed (applied) upon one of the first or second structural layers and then dried before the other layer is pressed against the dried adhesive layer and the adhesive is finally crosslinked (cured).

Crosslinking (curing) is achieved by heating the composite at a temperature of from about 125 degrees Celsius to about 150 degrees Celsius for about 1 hour for the first type (phenolic resin, epoxy resin, and/or melamine formaldehyde resin) of crosslinking (curing) agent. If a water-dispersible polyisocyanate is used, the need to bake parts after molding is eliminated, and curing is effected by maintaining the composite at room temperature for a period of about 1 week.

In one embodiment where either the first or second layer is thermoplastic elastomer, the layer is made of polyester elastomer (such as Dupont's Hytrel™). In another embodiment where either the first or second layer is polytetrafluoroethylene (such as DuPont's Teflon™), the surface of the polytetrafluoroethylene is chemically etched (or etched with a process such as electron beam treatment) before adhesive is applied to the etched surface or the etched surface is pressed against the dried adhesive layer.

Various useful examples of composites made with the aqueous phenoxy dispersion adhesive compositions include a dynamic seal, a static seal, a gasket, a pump diaphragm, a hose, an encoder, and an o-ring.

### EXAMPLE 1

Three waterborne epoxy resins and one water-dispersible diisocyanate are screened as curatives in waterborne phenoxy adhesive compositions. The waterborne phenoxy adhesive composition test formulations are prepared by stirring selected curatives into the waterborne phenoxy resin according to the gram weights indicated in Table 1 and adding additional water to adjust all compositions to the equivalent weight percent solids content.

TABLE 1

| | Sample Number | | | | | | | | | | |
|---|---|---|---|---|---|---|---|---|---|---|---|
| Adhesive Components | 1 | 2 | 3 | 4 | 5 | 6 | 7 | 8 | 9 | 10 | 11 |
| PKHW 34 Phenoxy Dispersion | 20.0 | 20.0 | 20.0 | 20.0 | 20.0 | 20.0 | 20.0 | 20.0 | 30.0 | 30.0 | 30.0 |
| Araldite PX3901 Epoxy Dispersion | 7.61 | 15.23 | 23.07 | | | | | | | | |
| Araldite XU3903 Epoxy Dispersion | | | | 5.46 | 10.92 | 16.54 | | | | | |
| Araldite PX3907 Epoxy Dispersion | | | | | | | 14.37 | 28.73 | | | |
| Accelerator 399 | 0.08 | 0.17 | 0.25 | 0.06 | 0.12 | 0.18 | 0.16 | 0.32 | | | |
| Bayhydur B302 Diosocyanate | | | | | | | | | 2.88 | 5.76 | 8.73 |
| Water | 9.21 | 15.75 | 22.49 | 6.02 | 10.71 | 15.54 | 18.67 | 26.01 | 10.85 | 17.71 | 24.77 |

Coatings of the each sample adhesive are prepared on cold-rolled steel panels with the coating applied to achieve a dry film thickness of approximately 0.5 mil. The coatings are baked as noted in Table 2. The state of cure of the film for each sample is evaluated by measuring solvent resistance to according to an MEK “double rub” test. In this test, the ball of a hammer is wrapped with felt and soaked in methyl ethyl ketone. The hammer is then rubbed back and forth across the coating. The number of rubs needed to expose the bare metal below the coating is counted and the number of rubs is indicated in Table 2. Samples 1-8 (Table 1) indicate performance for waterborne epoxy curative recipes. Samples 9-11 indicate performance for waterborne diisocyanate curative recipes.

TABLE 2

| | Conditions | | | | | |
|---|---|---|---|---|---|---|
| Sample | 125 deg C. | 125 deg C. | 150 deg C. | 125 deg C. | Room temp | Room temp |
| Number | for 1 hour | for 4 hours | for 15 min | for 20 min | for 1 day | for 10 days |
| 1 | 8 | 9 | 10 | | | |
| 2 | 25 | 40 | 12 | | | |
| 3 | 27 | 45 | 5 | | | |
| 4 | 7 | 10 | 5 | | | |
| 5 | 40 | 37 | 6 | | | |
| 6 | 15 | 20 | 4 | | | |
| 7 | 5 | 14 | 4 | | | |
| 8 | 10 | 6 | 8 | | | |
| 9 | | | | 60 | | |
| 10 | | | | 90+ | | |
| 11 | | | | 90+ | 11 | 90+ |

### EXAMPLE 2

Chemlok 210, a solvent-borne thermoplastic phenoxy resin adhesive manufactured by Lord Corp., is coated on a cold-rolled steel panel at a thickness of about 0.5 mil, and the adhesive is cured. An MEK “double rub” test is performed on the coated panel according to the procedure of Example 1, and a performance of less than 10 MEK double rubs is noted.

### EXAMPLE 3

From the screening trials of Example 1, Test sample formulations #5, 10 and 11 are selected for additional testing. Composite structures of a thermoplastic elastomer adhesively bonded to an iron-phosphate steel insert are prepared as follows. A first set of phosphate steel inserts are coated with example adhesive #5, #10 or #11 by spray application to achieve a dried film thickness of from about 0.8 to about 1.0 mil. A second set of phosphated steel inserts are spray coated with Chemlok 210 to achieve the same dried film thickness as the first set of steel inserts. The adhesive-coated steel inserts are placed in a mold cavity. A compound based upon Hytrel thermoplastic elastomer is injection-molded into the cavity. Upon opening of the mold, an adhesive bond is noted between the thermoplastic elastomer and each adhesive coated steel insert. Composite seals based upon adhesive example #5 are then cured in an oven for 1 hour at 125° C. Composite seals based upon adhesive examples #10 and #11 are cured for 20 minutes at 125° C. or aged for 1 week at room temperature prior to additional testing.

The resulting composite seals are immersed in Fuel C. Adhesion is monitored on a daily basis. All second set steel inserts indicate delamination within 24 hours. Example #10 exhibited delamination after 48 hours. Examples #5 and #11 indicated no loss of adhesion after aging for 1 week in Fuel C.

The aqueous phenoxy dispersion adhesive compositions provide cured adhesives having a high resistance to typical automotive fluids. Another benefit of aqueous phenoxy dispersion adhesive compositions is that waterborne raw materials inherently augment reduction and/or elimination of the hazardous solvents in the workplace (insofar as non-aqueous adhesives are usually dissolved in a solvent).

The examples and other embodiments described herein are exemplary and not intended to be limiting in describing the full scope of compositions and methods of this invention. Equivalent changes, modifications and variations of specific embodiments, materials, compositions and methods may be made within the scope of the present invention, with substantially similar results.

What is claimed is:

1. A dispersion composition, comprising:
(a) from about 30 to about 95 weight percent water;
(b) phenoxy resin dispersed in said water; and
(c) crosslinking agent for said phenoxy resin dispersed in said water.

2. A composition according to claim 1 wherein said phenoxy is a copolymer derived from bisphenol A and epichlorohydrin.

3. A composition according to claim 1 wherein said phenoxy has the repeating structural formula
—[OC₆H₄C(CH₃)₂C₆H₄OCH₂CH(OH)CH₂]ₙ—
wherein n is from about 35 to about 120.

4. A composition according to claim 1 wherein said crosslinking agent comprises resin selected from the group consisting of phenolic resin, epoxy resin, melamine formaldehyde resin, and combinations thereof.

5. A composition according to claim 1 wherein said crosslinking agent comprises water-dispersible polyisocyanate.

6. A composition according to claim 1 wherein said phenoxy has a molecular weight of from about 10,000 to about 35,000.

7. A composition according to claim 1 wherein said crosslinking agent has a molecular weight of from about 1,000 to about 4,000.

8. A composition according to claim 1 wherein said dispersion composition comprises an emulsion.

9. A composition according to claim 1 wherein said dispersion composition comprises a suspension.

10. A composition according to claim 4 wherein said phenoxy resin is from about 30 to about 70 weight percent of a dry weight combination of said phenoxy resin and said crosslinking agent.

11. A composition according to claim 4 wherein said phenoxy resin is from about 45 to about 55 weight percent of a dry weight combination of said phenoxy resin and said crosslinking agent.

12. A composition according to claim 5 wherein said phenoxy resin is from about 70 to about 90 weight percent of a dry weight combination of said phenoxy resin and said polyisocyanate.

13. A composition according to claim 5 wherein said phenoxy resin is from about 80 to about 90 weight percent of a dry weight combination of said phenoxy resin and said polyisocyanate.

14. A method for making an aqueous adhesive dispersion composition, comprising:
dispersively admixing phenoxy resin and crosslinking agent for said phenoxy resin into water, wherein said water comprises from about 30 to about 95 weight percent of said aqueous dispersion.

15. A method according to claim 14 wherein said phenoxy is a copolymer derived from bisphenol A and epichlorohydrin.

16. A method according to claim 14 wherein said phenoxy has the repeating structural formula
—[OC₆H₄C(CH₃)₂C₆H₄OCH₂CH(OH)CH₂]ₙ—
wherein n is from about 35 to about 120.

17. A method according to claim 14 wherein said crosslinking agent comprises resin selected from the group consisting of phenolic resin, epoxy resin, melamine formaldehyde resin, and combinations thereof.

18. A method according to claim 14 wherein said crosslinking agent comprises water-dispersible polyisocyanate.

19. A method according to claim 14 wherein said phenoxy has a molecular weight of from about 10,000 to about 35,000.

20. A method according to claim 14 wherein said crosslinking agent has a molecular weight of from about 1,000 to about 4,000.

21. A method according to claim 14 wherein said dispersively admixing admixes an emulsion.

22. A method according to claim 14 wherein said dispersively admixing admixes a suspension.

23. A method according to claim 17 wherein said phenoxy resin is from about 30 to about 70 weight percent of a dry weight combination of said phenoxy resin and said crosslinking agent.

24. A method according to claim 17 wherein said phenoxy resin is from about 45 to about 55 weight percent of a dry weight combination of said phenoxy resin and said crosslinking agent.

25. A method according to claim 18 wherein said phenoxy resin is from about 70 to about 90 weight percent of a dry weight combination of said phenoxy resin and said polyisocyanate.

26. A method according to claim 18 wherein said phenoxy resin is from about 80 to about 90 weight percent of a dry weight combination of said phenoxy resin and said polyisocyanate.

27. A composite comprising:
(a) a first structural layer comprising a first material selected from the group consisting of polytetrafluoroethylene, thermoplastic vulcanizate, thermoplastic elastomer, and metal;
(b) a second structural layer comprising a second material selected from the group consisting of polytetrafluoroethylene, thermoplastic vulcanizate, thermoplastic elastomer, and metal; and
(c) an adhesive layer disposed between said first and second structural layers, said adhesive layer cured from an adhesive dispersion composition comprising from about 30 to about 95 weight percent water, phenoxy resin dispersed in said water, and crosslinking agent for said phenoxy resin dispersed in said water.

28. A composite according to claim 27 wherein said thermoplastic elastomer of either of said first and said second layer comprises polyester elastomer.

29. A composite according to claim 27 wherein said phenoxy is a copolymer derived from bisphenol A and epichlorohydrin.

30. A composite according to claim 27 wherein said phenoxy has the repeating structural formula
—[OC₆H₄C(CH₃)₂C₆H₄OCH₂CH(OH)CH₂]ₙ—
wherein n is from about 35 to about 120.

31. A composite according to claim 27 wherein said crosslinking agent comprises resin selected from the group consisting of phenolic resin, epoxy resin, melamine formaldehyde resin, and combinations thereof.

32. A composite according to claim 27 wherein said crosslinking agent comprises water-dispersible polyisocyanate.

33. A composite according to claim 27 wherein said phenoxy has a molecular weight of from about 10,000 to about 35,000.

34. A composite according to claim 27 wherein said crosslinking agent has a molecular weight of from about 1,000 to about 4,000.

35. A composite according to claim 27 wherein said dispersion composition comprises an emulsion.

36. A composite according to claim 27 wherein said dispersion composition comprises a suspension.

37. A composite according to claim 31 wherein said phenoxy resin is from about 30 to about 70 weight percent of a dry weight combination of said phenoxy resin and said crosslinking agent.

38. A composite according to claim 31 wherein said phenoxy resin is from about 45 to about 55 weight percent of a dry weight combination of said phenoxy resin and said crosslinking agent.

39. A composite according to claim 32 wherein said phenoxy resin is from about 70 to about 90 weight percent of a dry weight combination of said phenoxy resin and said polyisocyanate.

40. A composite according to claim 32 wherein said phenoxy resin is from about 80 to about 90 weight percent of a dry weight combination of said phenoxy resin and said polyisocyanate.

41. A method for making a composite, comprising:
(a) admixing an aqueous adhesive dispersion of phenoxy resin and crosslinking agent for said phenoxy resin, wherein water comprises from about 30 to about 95 weight percent of said aqueous dispersion;
(b) providing a first structural layer for said composite, said first structural layer comprising a first material selected from the group consisting of polytetrafluoroethylene, thermoplastic vulcanizate, thermoplastic elastomer, and metal;
(c) applying said adhesive dispersion as an adhesive layer to said first layer;
(d) attaching a second structural layer against said adhesive layer, said second structural layer comprising a second material selected from the group consisting of polytetrafluoroethylene, thermoplastic vulcanizate, thermoplastic elastomer, and metal; and
(e) curing said adhesive layer.

42. A method according to claim 41 wherein said admixing admixes said adhesive for from about 12 to about 20 minutes.

43. A method according to claim 41 wherein said thermoplastic elastomer of either of said first and said second layer comprises polyester elastomer.

44. A method according to claim 41 wherein said phenoxy is a copolymer derived from bisphenol A and epichlorohydrin.

45. A method according to claim 41 wherein said phenoxy has the repeating structural formula
—[OC₆H₄C(CH₃)₂C₆H₄OCH₂CH(OH)CH₂]ₙ—
wherein n is from about 35 to about 120.

46. A method according to claim 41 wherein said crosslinking agent comprises resin selected from the group consisting of phenolic resin, epoxy resin, melamine formaldehyde resin, and combinations thereof.

47. A method according to claim 46 wherein said applying is performed within about 2 hours after said admixing.

48. A method according to claim 46 wherein said curing comprises heating said composite at a temperature of from about 125 degrees Celsius to about 150 degrees Celsius for about 1 hour.

49. A method according to claim 41 wherein said crosslinking agent comprises water-dispersible polyisocyanate.

50. A method according to claim 49 wherein said applying is performed within about 24 hours after said admixing.

51. A method according to claim 41 wherein said phenoxy has a molecular weight of from about 10,000 to about 35,000.

52. A method according to claim 41 wherein said crosslinking agent has a molecular weight of from about 1,000 to about 4,000.

53. A method according to claim 41 wherein said admixing admixes an emulsion.

54. A method according to claim 41 wherein said admixing admixes a suspension.

55. A method according to claim 46 wherein said phenoxy resin is from about 30 to about 70 weight percent of a dry weight combination of said phenoxy resin and said crosslinking agent.

56. A method according to claim 46 wherein said phenoxy resin is from about 45 to about 55 weight percent of a dry weight combination of said phenoxy resin and said crosslinking agent.

57. A method according to claim 47 wherein said phenoxy resin is from about 70 to about 90 weight percent of a dry weight combination of said phenoxy resin and said polyisocyanate.

58. A method according to claim 47 wherein said phenoxy resin is from about 80 to about 90 weight percent of a dry weight combination of said phenoxy resin and said polyisocyanate.

59. A method according to claim 41 wherein said applying further comprises drying said adhesive layer.

60. A method according to claim 41 wherein said providing of polytetrafluoroethylene further comprises etching a surface of said first structural layer prior to said applying said adhesive to said first structural layer, and said applying applies said adhesive to said surface that was etched.

61. A method according to claim 41 wherein said attaching of polytetrafluoroethylene further comprises etching a surface of said second structural layer and positioning said surface that was etched against said adhesive layer.

62. A composite article made by a process, said process comprising the method according to claim 41.

63. The composite article of claim 62 wherein said composite article is any of a dynamic seal, a static seal, a gasket, a pump diaphragm, a hose, an encoder, and an o-ring.
